(19) United States
(12) Patent Application Publication
(10) Pub. No.: US 2006/0159253 A1
(43) Pub. Date: Jul. 20, 2006

(54) Agent status indicator

(76) Inventors: Joaquin Garcia Fink, Mountain View, CA (US); Janaki Kumar, Palo Alto, CA (US); Johnnie Wilkenschildt, San Francisco, CA (US); L.W. Bryan Charnock, Harleysville, PA (US)

Correspondence Address: FISH & RICHARDSON, P.C., PO BOX 1022, MINNEAPOLIS, MN, 55440-1022, US

(21) Appl. No.: 11/386,123

(22) Filed: Mar. 20, 2006

Related U.S. Application Data
(63) Continuation of application No. 10/693,640, filed on Oct. 24, 2003, now abandoned.

(51) Int. Cl. H04M 3/00; H04M 5/00

(52) U.S. Cl. 379/265.11

(57) ABSTRACT

An agent or customer reprehensive of a business may require a system to monitor communications with one or more customers. In one implementation, the system may include a graphical user interface for the agent, statistics relating to the agent's contact with one or more customers, and an indicator in the graphical user interface. The indicator may include a work status of the agent and an amount of time an agent spends in the work status. The statistics may include the work status of the agent and the amount of time the agent spends in the work status.

### CROSS-REFERENCE TO RELATED APPLICATIONS

This application is a continuation application of and claims priority to U.S. patent application Ser. No. 10/693,640, filed Oct. 24, 2003.

### BACKGROUND

The following description relates to customer service, for example, providing customer tools and services to customer service agents and customer service call centers. Certain businesses, such as web-based or telephone-based retail stores and stores that rely on catalog sales, may depend on having high-quality customer service. Other businesses may have one or more departments or groups that provide customer service for customer calls, such as a customer support hotline for a public utility company, a service department for an information technology (IT) business, or an information directory service that provides information for a number of businesses to customers.

A factor in providing quality service to callers involves the responsiveness of the customer service agent in handling the call. A common complaint of customers when they call for service is the amount of time spent waiting for service. Such complaints from customers can lead to poor reviews of a business's customer service department. The poor reviews can hurt the sales and reputation of businesses and organizations. Furthermore, poor reviews can be spread through word-of-mouth communication and can be posted on websites, such as Bizrate.com and Consumer Reports Online.

When customer contact agents answer a call, they should know how long they spend on the call. In order to have good customer service reviews, the agents should not keep callers waiting or put callers on hold for long periods of time, even if completing other tasks. In addition to knowing how much time they spend on a call, the agents should know the amount of time they spent doing wrap-up work after the call (e.g., post-call work). When an agent is performing post-call work, that agent typically is not handling another incoming call. Hence, the throughput of a customer call or contact center can be reduced if agents are spending their time on tasks other than handling incoming calls.

Contact centers can have one or more managers or supervisors to handle workflow, calls, and agent concerns. To improve the responsiveness of agents to calls, the supervisor may want to know (1) when agents are available for calls, (2) statistics on the call (e.g., amount of agent time spent on calls), and (3) down time between calls (e.g., time spent on breaks by agents). Without knowledge of these factors, a supervisor may not know how to improve the responsiveness of the managed agents and the quality of service provided to callers.

### SUMMARY

The present application describes systems and techniques relating to communications for one or more agents in a contact center.

In one implementation, a system can include a graphical user interface that is operative to indicate at least one of a number of availability states of an agent, and a routing system that is operative to control the routing of customer communications to the agent based on a current availability state of the agent.

In another implementation, a method can present a work status indicator in a graphical user interface and control of the routing of customer communications to the agent based on a current availability state of the agent. The work status indicator can identify at least one of a number of availability states of the agent.

In another case, an article comprising a machine-readable medium can include machine-executable instructions operative to cause one or more machines to present a work status indicator in a graphical user interface and control of the routing of customer communications to the agent based on a current availability state of the agent. The work status indicator can identify at least one of a number of availability states of an agent.

For any of the implementations or cases described above, the customer communication can include a telephone call and an electronic communication, such as an email and/or a chat session. The availability state can include an available state and an unavailable state. The work status indicator can be operative to transition the current availability state of the agent to another one of the number of availability states in response to at least one of a selection by the agent, the end of a timeout period, an initiation of client communication, and a termination of a client communication.

Moreover, in any of the implementations or cases described above, the availability states can include a wrap up state. The work status indicator can transition from an unavailable state to the wrap up state after an agent completes a client communication session, and the work status indicator can transition from the wrap up state to the available state after a predetermined time. The graphical user interface may also include a statistics indicator that is operative to indicate an amount of time the agent is in the current availability state.

The systems and techniques described here may provide one or more of the following advantages. For example, a status indicator in a graphical user interface can show how much time an agent spends on a call, and how much time an agent spends in post-call wrap-up work. Agents will also know how much time customers have been kept on the call, or waiting on hold. The time information can be displayed in one or more locations in the graphical user interface. In another example, one or more supervisors of the agents can easily ascertain the amount of time callers wait for service and can help improve the quality of service provided to callers. Supervisors can have the benefit of viewing statistics on a number of agents or a single agent. With this information, supervisors can implement rules and procedures to enhance the performance of the agents under their control and this improves overall efficiency and call throughput of the contact center.

As another potential benefit, the status indicator can be used by automatic processes to route incoming calls to agents who are available to handle a call (e.g., in the ready work mode). These automatic processes can reduce the amount of time callers spend waiting for a call to get routed, and reduce the need for an operator or other personnel to route calls. Hence, use of the status indicator can improve a caller's view of an important service aspect (e.g., responsiveness) of a business.

Details of one or more implementations are set forth in the accompanying drawings and the description below. Other features and advantages will be apparent from the description and drawings, and from the claims.

### DRAWING DESCRIPTIONS

FIGS. 1A-1B show an exemplary graphical user interface with the agent status indicator.

FIGS. 2A-2D, 3 show examples of the various work modes of the agent status indicator.

FIG. 4 shows an exemplary flowchart of facilitating an incoming call.

FIG. 5 shows an example of a block diagram of a contact center.

Like reference symbols in the various drawings indicate like elements.

### DETAILED DESCRIPTION

The systems and techniques described here relate to providing status information for one or more contact center agents in a graphical user interface (GUI).

A status indicator in the GUI can show whether a customer service agent or representative is ready to handle communications, not ready or unable to handle communications, or is doing wrap-up work after communications. The communications can be voice-based communications, such as a telephone call, and/or text-based communications, such as email or a chat session. The status indicator is prominently shown in the context persistent area of the GUI, which, in an embodiment, is always visible to the agent regardless of the state of the transaction or interaction.

In general, the status indicator can have three work modes: ready, not ready, and, wrap up. The status indicator can include a timer that shows the amount of time the agent spends in each of the three work modes. Alternatively, the status indicator can include a timer that shows the time duration of the contact, regardless of the state of the work mode. Hence, customer service agents will know how long they spent on a call or performing post-call wrap-up work. They will also know how long they have kept customers waiting or on hold.

Certain modes or statuses, such as the wrap-up mode, may interact with features that are customizable to the function of a particular business. During wrap-up mode, for example, an agent may need to contact a shipping department of a business to arrange for special handling of an order. The wrap-up mode may provide links or interfaces with the shipping department of that business in a portion of the GUI.

Supervisors of the agents can easily ascertain a key aspect of the quality of service the agents provide to the customers, i.e., the amount of time customers wait for service. The supervisors can view the statistics of a number of agents or a single agent. Along with other performance parameters, the supervisors can accordingly implement rules and procedures to enhance the performance of the agents under their control.

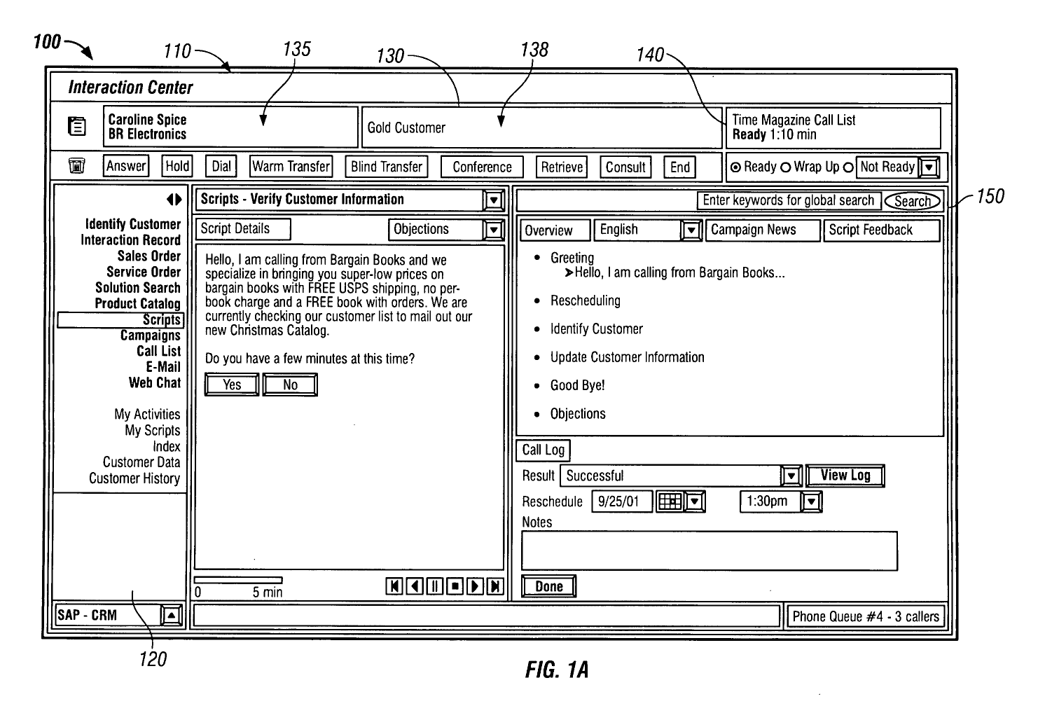

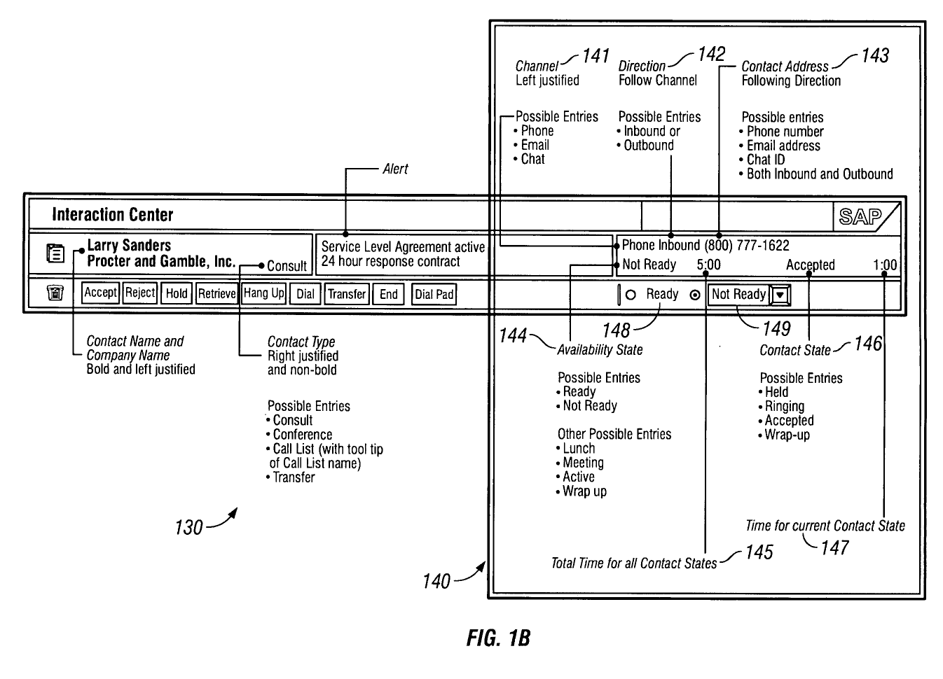

FIG. 1A shows exemplary GUI 100 with an agent status indicator 140. The GUI 100 can be presented on a display device for an agent that handles calls from one or more persons. In this example, the GUI has five sections: (1) a title bar 110; (2) a context area 130; (3) an agent status indicator 140; (4) a workspace 150; and (5) a navigation bar 120. The navigation bar 120 can display certain links, shortcuts, or headers for the agent's workspace 150. The context area 130 can include the agent's status indicator 140, as well as a section for the caller's name and/or organization 135, and a section for alerts or special caller information 138.

FIG. 1B shows the agent status indicator 140 in context area 130 with greater detail. In this illustration, the indicator 140 can have several sections, with each section providing information to the agent. Once such section is a channel section 141 that can show whether the contact with the customer is with a phone, an email, or a chat session. A direction section 142 can show if the customer initiated contact with the agent (e.g., inbound direction), or if the agent initiated contact with the customer (e.g., outbound direction). A contact address section 143 can show the phone number, email address, and chat identifier (ID) for the customer in either inbound or outbound directions.

Another section in the indicator 140 can show the availability state 144 of the agent. The agent can select a “ready” or “not ready” indicator 148, 149. The indicator 149 can have a customizable pull-down menu to display other possible statuses of the agent, such as “at lunch”, “at a meeting”, “currently active” with service, or “wrapping up” post-call work. Other sections of the indicator 140 are also customizable and may be in various locations within the indicator 140.

The indicator 140 can also show the total time for the current contact state 147 and the time spent on the current contact state 147. The contact state 146 can show if the customer is on hold and if the call or attempted contact is currently ringing. The contact state 146 can also show if the call or contact has been accepted or if the agent is in the after call/contact wrap-up state.

Although several channels 141 have been shown with the channels of chat, email, and phone, the most time-sensitive channel is when an agent is on a phone call with a customer. The second most time-sensitive channel is a chat session, and the third most time-sensitive channel is an email channel. In terms of responsiveness, a customer typically has higher expectations of customer service when they are on the phone with an agent (e.g., a voice-based communication channel can have higher priority than a text-based communication channel). Since an agent can multi-task and handle any or a combination of the three channels, the channel section 141 can display one or all of the possible channel types simultaneously. The contact address section 143, availability state section 144, contact state section 146, channel direction section 142, and time sections 145, 147 can correspondingly show one or any combination of all three of the possible channels.

In one implementation of the status indicator 140, an agent can handle one customer channel at a time in a serial manner. In another implementation, the agent can handle multiple customers in parallel with the same type of channel. The agent may also handle multiple customers in parallel with various types of channels.

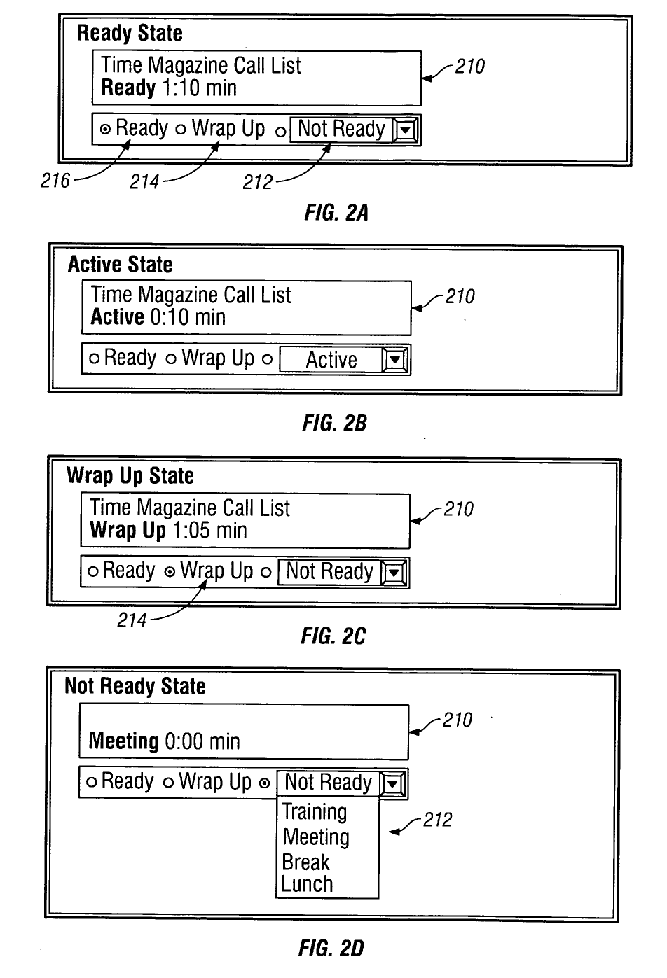

FIGS. 2A-2D illustrates the various work modes of the agent status indicator. In this implementation, the agent status indicator has a section 210 for messages and buttons 216, 214 for “Ready” and “Wrap Up”. There is also a pull-down menu 212 that can be customized to show other statuses of the agent, such as “Not Ready” or “Active”.

FIG. 2A shows an example of the status indicator when the agent is in the “Ready” state. In the “Ready” state the agent is available to receive (or send) calls, emails, and chat messages from (or to) customers. The agents' “Ready” button 216 may be highlighted in this state, and the indicator will show the agent has been in the ready state for a certain amount of time (e.g., 1:10 minutes) in indicator section 210.

FIG. 2B shows an example of the status indicator when the agent is in the “Active” state. In the “Active” state, the agent is currently handling a call, chat, or email with a customer. The “Active” state begins when either the agent initiates communication with a customer or when a customer contacts the agent. For example, the “Active” state can begin when the agent picks up a call. The status indicator's system can identify when communication is established, or is in the process of being established between the agent and the customer, and automatically place the status indicator in the “Active” state. The pull-down menu 212 can automatically change to show that the agent is in the “Active” state. The indicator can show that the agent has been in the “Active” state for a certain amount of time (e.g., 0:10 minutes) in indicator section 210. In the case of a phone call, the amount of time shown in the indicator can represent call duration.

FIG. 2C shows an example of the status indicator when the agent is in the “Wrap Up” state. In this state, the agent may be performing tasks related to post-call or post-communication work. Such post-call work can include making an entry or a record of a conversation, making notes about the customer, handling orders or special requests, contacting another department in a business with respect to the customer, and the like. In this state, the agent may be busy with tasks other than handling a new communication or call. Hence, the agent may not be able to handle additional communications until they have reached a stopping point in their post-communication tasks.

In the “Wrap Up” state, a button 214 can be highlighted to inform the agent of the current status. The status indicator can show how long the agent has been in the “Wrap Up” state in indicator section 210. In one implementation, when the agent completes a call, a system or process may automatically put the agent into a “ready” state, and the agent can choose to select the “Wrap Up” status if the agent needs time for post-wrap up work. The system or process may include a hardware or software switch and/or switching logic. In another implementation, the switch may automatically put the agent in the “Wrap Up” state, and the agent can manually select another state when completed with the post-call work.

FIG. 2D illustrates the status indicator in the “Not Ready” state. In this state, the agent can select another identifier in the pull-down menu 212 for a more descriptive reason of why the agent is not ready. For example, the agent can be in a meeting, at lunch, or on a break. The status indicator can highlight the “Not Ready” button next to the pull-down menu, and show an amount of time the agent has spent in this mode.

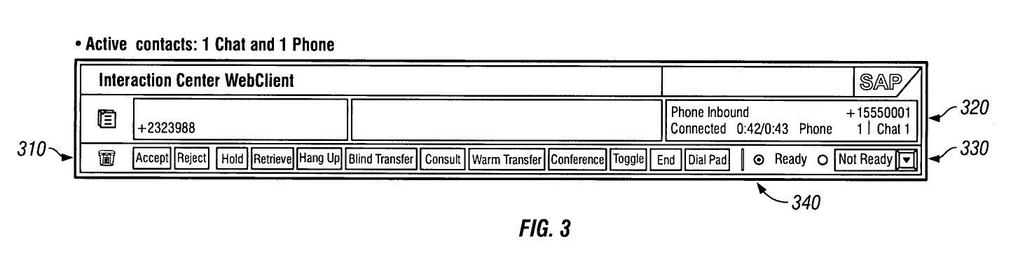

FIG. 3 shows an example of the agent status indicator 320 under a given work mode. FIG. 3 shows the agent status indicator 320 when the agent is currently in both a chat session and a phone conversation. The agent status indicator 320 can show the time (e.g., 0:42 minutes) that the agent has been in the current state (e.g., connected or hold) and the overall time (e.g., 0:43 minutes) of the phone call. Hence, the agent status indicator 320 can show one or more customer connections with the agent, in which those customer connections may be in combination (e.g., parallel or simultaneously), and those customer connections may vary in the type of connection (e.g., phone call, email, chat). An agent in a customer call or contact center can have their status information available for managers and supervisors.

In another implementation, the agent may be processing two chat sessions at the same time. For this situation, the agent status indicator may show other types of availability. For instance, the agent may be available for a third chat session, but not for an incoming phone call. Instead of using a single status attribute, such as “Ready”, the status indicator can show a work mode on whether or not the agent is available, in general, independent of the type of channels. The customer contact center can then know a more specific status of the user. For instance, the agent can be in a “logged off” work mode in which the contact center will know that the agent is not available and not logged on to the contact center. The agent can also be in a “logged on—ready” state or a “logged on—not ready” state.

When the agent is in a “logged on—ready” state, the agent is logged on and ready to process communications. This state can be independent of whether or not the agent is currently processing communications—this state means that the agent is “present” (e.g., logged on and not busy with work that is not related to the contact center). The “logged on—ready” state, as well as the “logged on—not ready” state, is independent of the type of channels—the agent can be in this state regardless of whatever channel of use. The channels for which the agent is available can be sent or reported to the contact center.

When the agent is in a “logged on—not ready” state the agent is logged on and not ready to process communications. The agent can select this work mode while processing one or more communications. In this case, the contact center can know that the agent is currently working on processing communications and cannot take additional assignments. The “logged on—not ready” state can also have customized status indicators, such as “lunch” or “coffee break”. The types of status indicators can be customized and defined by the contact center.

Each communication of the contact center from any of the channels can have an item processing status. Each communication, whether incoming or outgoing, can be assigned to a type of item status. Some examples of the processing statuses of communication items can include the following: “active”—the user is currently processing the item; “suspended”—the user has currently suspended work on the item but will resume later; “wrap up” the user is currently doing wrap up work in connection with the item; and “not in process”—none of the above, or the item may or may not be assigned to an agent. The contact center can monitor the status of individual items.

The item processing status can be determined and updated, directly and indirectly, by an operation on the item itself. For instance, when one operation for an item has been completed (e.g., a phone call has ended) and another operation commences (e.g., wrap up work begins) the processing status for that communication item can change (e.g., from “active” to “wrap up”). These operations can be triggered by the agent (e.g., the agent initiates a phone call), by a remote party (e.g., an incoming phone call), or by some event (e.g., a phone call is disconnected due to a network failure). In another example, a phone call on hold can change the item processing status by the operation of placing the call on hold. The call on hold can be considered “suspended” or “active”. The contact center has the ability to define the types of item processing statuses. The status identifier's system can maintain the status for each item, as well as a record of changes or updates for each item.

The type of user work modes can be defined by the contact center (e.g., in cases where users log on and off using a telephone set). The type of user work modes can also be defined by another method, such as the Simple Object Access Protocol (SOAP) method—a protocol for exchanging messages between computer software, typically in the form of software components.

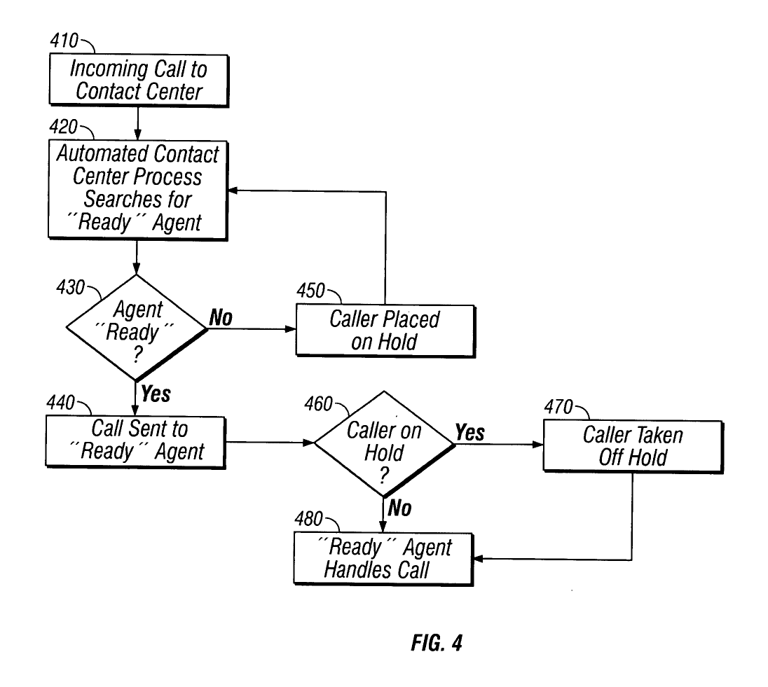

FIG. 4 shows an exemplary flowchart of facilitating an incoming call 410 to a customer contact center. When the call reaches the contact center, an automated process, such as a software program and/or switching logic, searches for an agent that is “ready” to receive a call at 430. The agent can select the “ready” status in the agent's status indicator, and the contact center can know the status of each of their agents. If an agent is “ready” at 430 then the call is sent to the “ready” agent at 440. If no agents are “ready” at 430 then the caller is placed on hold at 450 and the automated contact center process continues to search for an agent until one is “ready” to handle the call. If a call is place on hold, the item/call may be assigned an item processing status of “suspended” or “hold”.

When the call is sent to the “ready” agent, that agent can handle the call at 480. Callers that were on hold can be automatically taken off hold when the agent accepts the call. If the call was on hold 460, then the item processing status can be changed to “active” at 470 as the “ready” agent handles the call at 480.

The status indicator can allow automatic processes to route incoming calls to agents who are available to handle a call (e.g., in the ready work mode). These automatic processes can reduce the amount of time callers spend waiting for a call to get routed, and reduce the need for an operator (e.g., reduced personnel) to route the calls. Hence, the status indicator can improve a caller's view of an important service aspect (e.g., responsiveness) of a business.

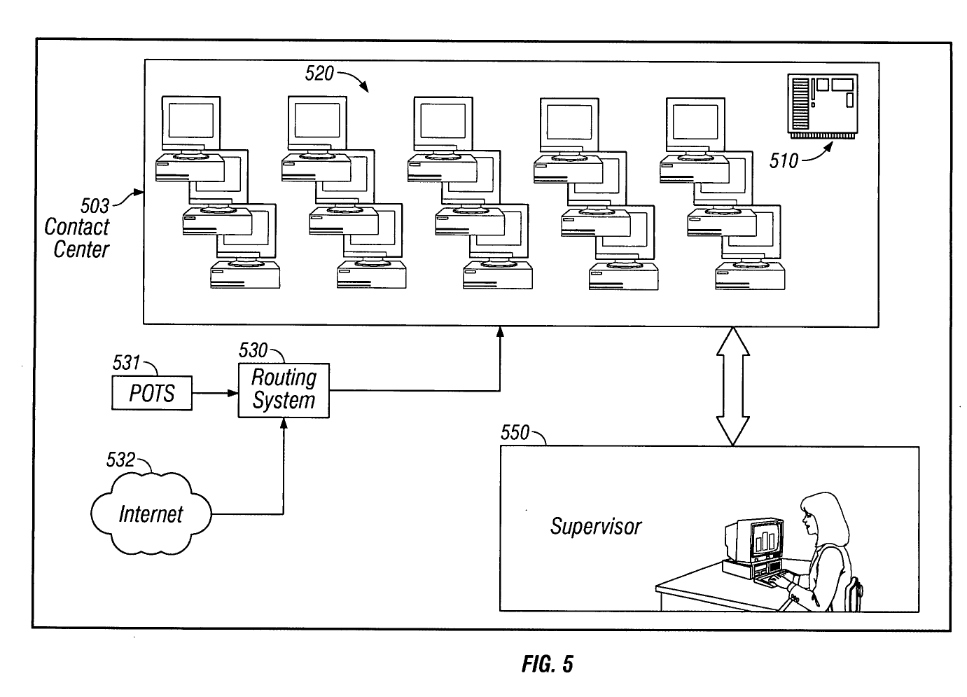

FIG. 5 shows an exemplary block diagram of a contact center. The contact center 503 can have one or more agents on one or more computers 520. The computers may be in a network and share a common repository or database 510. The network may have a network of telephony equipment and/or a network of computers. The contact center 503 may also include a network of telephony equipment. A routing system 530 may be used to route calls from a POTS (Plain Old Telephone Service) 531 to agent telephones and/or to route electronic communications (e.g., emails and chat sessions) to agent computers from the Internet 532. An agent's status indicator can be shown on each computer, and the status of each agent may be stored in the database and monitored by another user in the contact center.

Contact centers can have one or more managers or supervisors 550 to handle workflow, calls, and agent concerns. To improve the responsiveness of agents to calls/communications, the supervisor may want to know (1) when agents are available for calls, (2) statistics on the call (e.g., amounts of time agents spent on calls), and (3) how long agents take breaks (e.g., down time) between calls. Without knowledge of these factors, a supervisor may not know how to improve the responsiveness of the managed agents, and a key aspect of the quality of service provided to callers.

The status indicator can provide information to managers and supervisors as to the availability of agents, the statistics on an agent's work (e.g., the amount of time spent on a call for a given customer), and the efficiency of one or more agents.

Even though FIG. 5 was described in regards to telephone calls, it may be described in regards to other forms of communications, such as emails or chats. Furthermore, the call may result from the transmission of voice telephony services over IP, the Internet Protocol, such as Voice over IP (VoIP) or Internet telephony.

In an embodiment, the system may highlight the status indicator to alert the agent to different situations. For example, the status indicator may be highlighted with a color (e.g., red) and/or may flash when the end of the wrap up period is approaching or when a client communication exceeds a recommended maximum time. Also, benchmarking statistics, such as, e.g., a maximum recommended call time or a calculated average agent call time, may be displayed near the status indicator.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

The software (also known as programs, software tools or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on one or more computers each having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. The components of the system can be interconnected by any form or medium of digital data communication (e.g., a communication network). Examples of communication networks include a local area network (“LAN”), a wide area network (“WAN”), a wireless local area network (“WLAN”), a personal area network (“PAN”), a mobile communication network using a multiple access technology (e.g., a cellular phone network with Code Division Multiple Access, “CDMA”), and the Internet.

The computing system can include clients 520 (FIG. 5) and servers 510. A client and server are generally remote from each other and typically interact through a communication network. The relationship of client and server arises by virtue of computer programs running on the respective computers and having a client-server relationship to each other.

Although only a few implementations have been described in detail above, other modifications are possible. There may be other communication scenarios not described. For example, the call center can be arranged so that a first set of agents give priority to handling telephone calls, a second set of agents give priority to handling chats, and a third set of agents give priority to handling emails. In another example, the call center can have one type of agent status indicator (e.g., a comprehensive status indicator with detailed status information) for agents handling large customers and businesses, and another type of agent status indicator (e.g., a scaled-down status indicator with little information) for agents handling individual customers and small businesses. The user interfaces described above may be referred to as panels, palettes, pages, views, or portions of other interfaces. The logic flow depicted in FIG. 4 does not require the particular order shown, or sequential order, to achieve desirable results. Other implementations may be within the scope of the following claims.

What is claimed is:

1. A system comprising:
a graphical user interface operative to indicate at least one of a plurality of availability states of an agent for each of a telephone call and at least one text-based electronic communication for customer communications; and
a routing system operative to control a routing of customer communications to the agent based on a current availability state of the agent, wherein the telephone call comprises a first priority and the at least one text-based electronic communication comprises a second priority, and wherein the first priority has a higher priority than the second priority.
